(19) United States
(12) Patent Application Publication
(10) Pub. No.: US 2015/0256510 A1
(43) Pub. Date: Sep. 10, 2015

(54) SYSTEM AND METHOD FOR NAME RESOLUTION OF REPLICATED COMPONENTS IN COMPUTING ENVIRONMENTS

(71) Applicant: CLOUDENDURE LTD., Ramat Gan (IL)

(72) Inventors: Jonathan CEDERBAUM, Tel Aviv (IL); Ofir EHRLICH, Netanya (IL); Ophir SETTER, Ramat Gan (IL); Roman ZEYDE, Afula (IL); Leonid FEINBERG, Ramat HaSharon (IL)

(73) Assignee: CLOUDENDURE LTD., RAMAT GAN (IL)

(21) Appl. No.: 14/639,594

(22) Filed: Mar. 5, 2015

Related U.S. Application Data
(60) Provisional application No. 61/948,052, filed on Mar. 5, 2014.

(51) Int. Cl. H04L 29/12; G06F 17/30

(52) U.S. Cl. CPC H04L 61/3015; G06F 17/30864; G06F 17/30575

(57) ABSTRACT

A system and method for name resolution of replicated components in computing environments (CEs). The method includes inserting, an alternate name-resolving server (NRS) as a first queried entry in a list of NRSs into a memory of a first replicated component, wherein the alternative NRS is communicatively connected to a second CE, the second CE comprising the first replicated component and the second replicated component, wherein the second replicated component is replicated from the first CE and includes a first original component.

### CROSS-REFERENCE TO RELATED APPLICATIONS

This application claims the benefit of U.S. Provisional Application No. 61/948,052 filed on Mar. 5, 2014, the contents of which are hereby incorporated by reference.

### TECHNICAL FIELD

The present disclosure relates generally to computing environments, and more particularly to name resolution for replicated components of computing environments.

### BACKGROUND

In a network, components such as machines, firewalls, routers, and switches typically communicate with each other using names to identify each component rather than an underlying address, which is typically an internet protocol (IP) address. This methodology has the advantage of ensuring that, even if the address of a component changes, other components will still be able to communicate with it as the change is transparent.

This method also presents an obvious disadvantage when creating replicas of the components. Replicated components will try to communicate with each other using original component names. For example, a first replicated component which is the replica of a first original component will attempt to communicate with a second original component. However, the first replicated component should be attempting to communicate with a second replicated component, which is the replica of the second original component.

Typical solutions to this communication problem include using a name-to-address server to modify records so that the names point to the newly replicated components, or modifying the original components so that they reference the names of the replicated components, which point to the new addresses. Often, this process takes a long time and may involve a risk of human error. Additionally, a lack of easy access to the name translation server may halt this process.

It would therefore be advantageous to provide a solution that would overcome the deficiencies of the prior art by resolving conflicting name issues in replicated components of computing environments.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

The disclosure relates in various embodiments to a method for name resolution of replicated components in computing environments (CEs). The method includes inserting, an alternate name-resolving server (NRS) as a first queried entry in a list of NRSs into a memory of a first replicated component, wherein the alternative NRS is communicatively connected to a second CE, the second CE comprising the first replicated component and the second replicated component, wherein the second replicated component is replicated from the first CE and includes a first original component.

The disclosure also relates in various embodiments to for name-to-address (N2A) resolution of a first replicated component in a first computing environment (CE). The method comprises a processing system; a memory containing instructions that, when executed by the processing system, configure the system to: insert at least an alternate name-resolving server (NRS) as a first queried entry in a list of NRSs into a memory of the first replicated component, wherein the at least an alternative NRS is communicatively connected to a second CE, the second CE includes the first replicated component and a second replicated component, wherein the second replicated component is replicated from the first CE and includes a first original component; receive, from the first replicated component, the name-to-name request, wherein the name-to-name request including a name of a second original component, the first CE comprises the second original component; translate the name of the second original component to a name of the second replicated component; send the name of the second replicated component to the at least NRS of the list of NRSs; and receive an address of the second replicated component.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic illustration of a first computing environment and a second computing environment according to an embodiment;

FIG. 2 is a schematic illustration of an alternate name-resolving server according to an embodiment;

FIG. 3 is a flowchart illustrating name resolution for replicated components in a computing environment according to an embodiment;

FIG. 4 is a flowchart illustrating translation of an original component name to a replicated component name according to an embodiment; and

FIG. 5 is a translation table between original component names and replicated component names according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

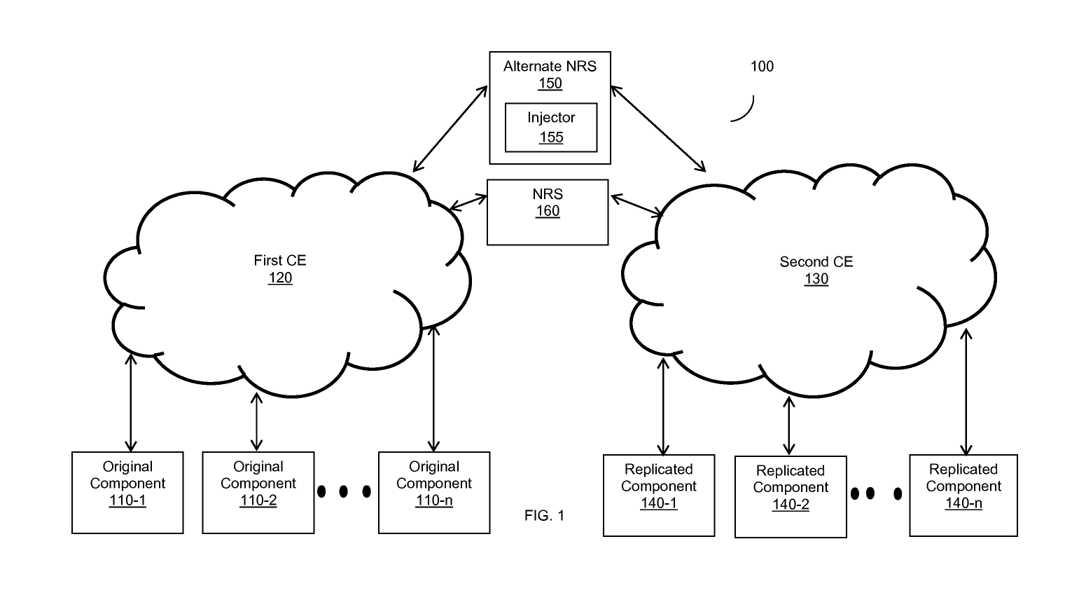

FIG. 1 is an exemplary and non-limiting schematic illustration 100 of a first computing environment (CE) 120 and a second CE 130 according to an embodiment. The first CE 120 is connected to a plurality of original components 110-1 through 110-N (hereinafter referred to individually as an original component 110 or collectively as original components 110, merely for simplicity purposes), and the second CE 130 is connected to a plurality of replicated components 140-1 through 140-N (hereinafter referred to individually as a replicated component 140 or collectively as replicated components 140, merely for simplicity purposes), in an embodiment wherein each replicated component corresponds to an original component. A component may be, but is not limited to, a machine, a firewall, a router, a switch, and the like.

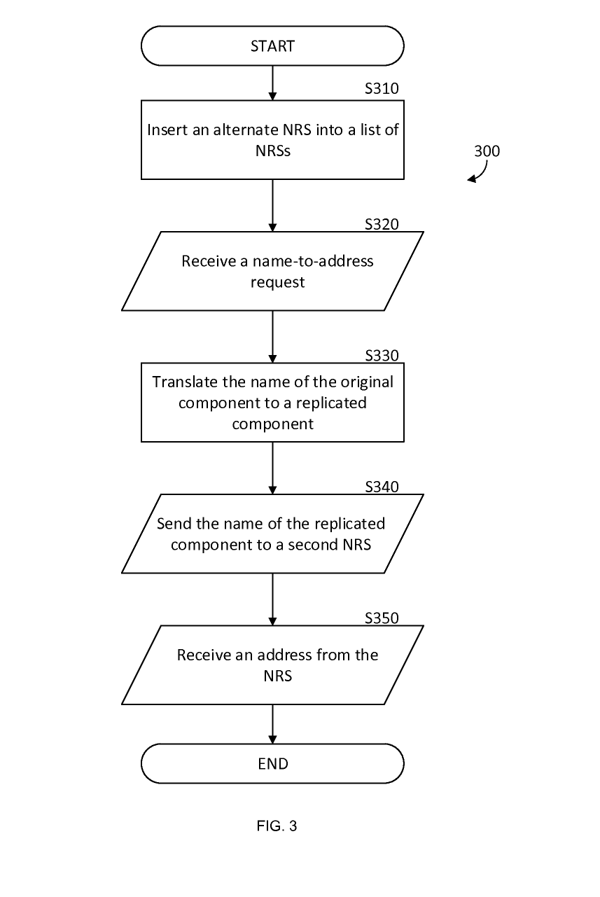

In some embodiments, the first and second CEs 120 and 130 are cloud-based computing environments (CBCEs). The original components 110 are replicated to the second CE 130 as the replicated components 140. An alternate name-resolving server (NRS) 150 is communicatively connected to the first CE 120 and to the second CE 130. In some embodiments, the alternate NRS 150 is communicatively connected to the second CE 130 and is not communicatively connected to the first CE 120. In certain embodiments, a plurality of alternate NRSs (without limitation on the disclosed embodiments, only one alternate NRS 150 is shown) are communicatively connected to the first CE 120 and to the second CE 130. In some embodiments, the alternate NRS 150 performs the methods described in more detail herein with respect to FIG. 3.

As a non-limiting example, an original component 110-1 is replicated in the second CE 130 as a replicated component 140-1. The replicated component 140-1 is configured to attempt to communicate with an original component 110-2. In order to communicate with the original component 110-2, the replicated component 140-1 requires an address for the original component 110-2. Replicated component 140-1 is configured to access a list of NRSs. In an embodiment, the alternate NRS 150 is the first server being queried.

The alternate NRS 150 is configured to translate the name of the original component 110-2 to the name of a replicated component 140-2. A request is sent to another NRS 160 to find the address of the replicated component 140-2. The request includes at least the name of the replicated component 140-2. The address of the replicated component 140-2 is sent to the replicated component 140-1, thereby ensuring that the replicated component 140-1 is able to communicate with the replicated component that it is intended to communicate with rather than unsuccessfully attempting to communicate with an original component. In this exemplary embodiment, the NRS 160 is communicatively connected to both the first CE 120 and to the second CE 130. In other embodiments, the NRS 160 may be communicatively connected to the second CE 130, but not communicatively connected to the first CE 120.

In an embodiment, the alternate NRS 150 may optionally contain an injector module 155. In various other embodiments, the injector module 155 may be executed on one or more replicated components, on a machine communicatively connected to one or more replicated components, or on a combination thereof. In an embodiment, an injector module 155 is utilized, he injector module 155 is at least configured to insert an alternate NRS (such as, e.g., the alternate NRS 150) as the first queried entry in a list of NRSs. Insertion of alternate NRSs into lists of NRSs is described further herein below with respect to FIG. 3.

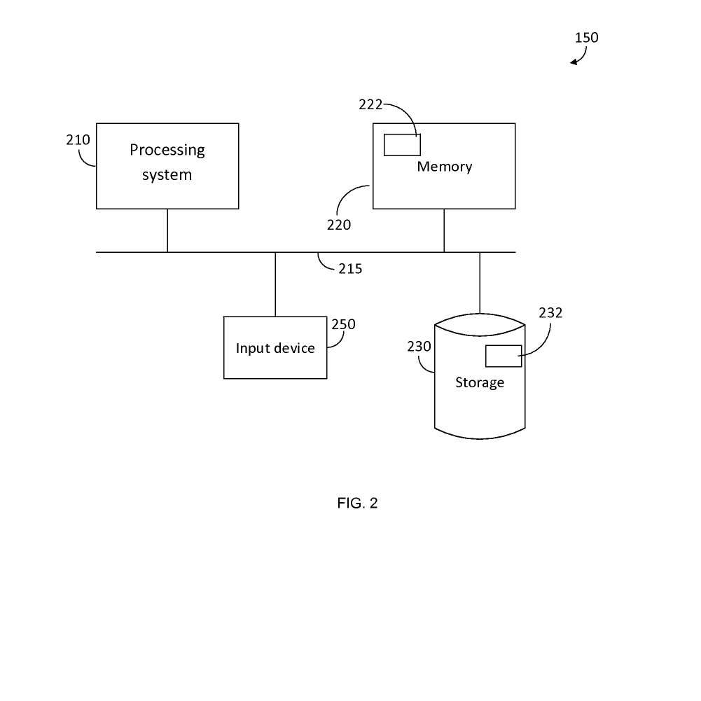

FIG. 2 is an exemplary and non-limiting schematic illustration of an alternate name resolving server (NRS) 150 in accordance with an embodiment. The alternate NRS 150 includes a processing system 210 that is connected via a bus 215 to a memory 220. The memory 220 includes a memory portion 222 that contains instructions that, when executed by the processing system 210, configure the alternate NRS 150 to perform the methods described in more detail herein, such as the method described with respect to FIG. 3.

The memory 220 may be further used as a working scratch pad for the processing system 210, as a temporary storage, and in other ways. The memory may include or be a part of volatile memory such as, but not limited to, random access memory (RAM) or non-volatile memory (NVM) such as, but not limited to, Flash memory. The processing system 210 may also be connected to a data storage 230 and an input device 250. The input device 250 may be, but is not limited to, a network interface. The data storage 230 may be used to store instructions that, when executed by the processing system 210, configure the alternate NRS 150 to perform the methods described in more detail herein. The data storage 230 may further comprise a storage portion 232 that may contain, but is not limited to, a name translation table for translating between original component names and replicated component names. In another embodiment, the translation table includes mapping of the original component names to the replicated component names and/or addresses (such as an internet protocol address).

The processing system 210 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system 210 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing unit, cause the processing unit to perform the various functions described herein.

FIG. 3 is an exemplary and non-limiting flowchart 300 illustrating resolving names for replicated components in a computing environment (CE) in accordance with an embodiment. In S310, an alternate NRS (e.g., the alternate NRS 150) is inserted as the first queried entry in a list of name resolving servers (NRSs).

Insertion may be performed by an alternate NRS (e.g., the alternate NRS 150). In certain embodiments, insertion may be performed by an injector module (e.g., the injector module 155). In FIG. 3 the injector module 155 is executed on the alternate NRS 150. However it should be apparent that the injector module 155 may be executed on one or more replicated components, on a machine communicatively connected to one or more replicated components, or any combinations thereof without departing from the scope of the disclosed embodiments. In some embodiments, the injector module 155 configures the alternate NRS to perform the methods described in more detail herein. The list of NRSs is accessible by a first replicated component in the CE.

In S320, a name-to-address (N2A) request is received by the alternate NRS, wherein the request includes at least a name of an original component.

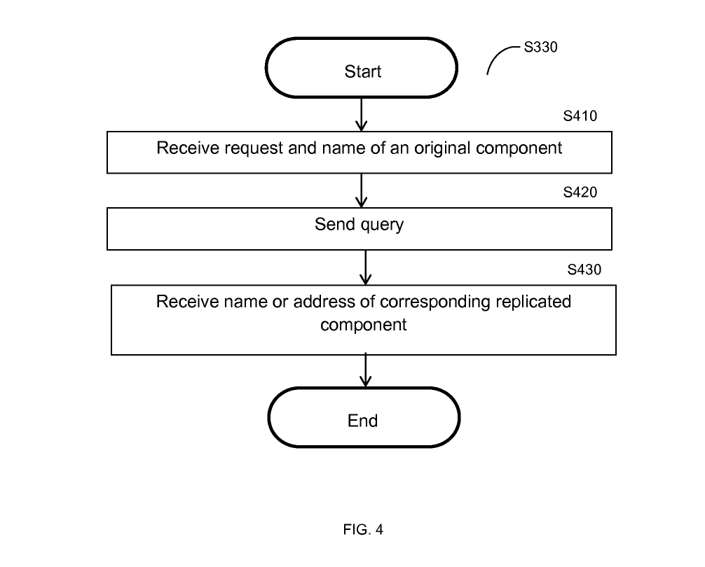

In S330, the name of the original component is translated to a name of a second replicated component. The second replicated component is a replica of the original component. In certain embodiments, translation is performed by sending, to a name-to-name (N2N) server, a request including at least the name of the original component, and by receiving, from the N2N server, a name or an address of the second replicated component corresponding to the name of the original component. In another embodiment, translation may be performed by querying a table stored on the alternate NRS. The stored table contains a translation between original component names and replicated component names or addresses. It should be apparent that a table for translation between original component names and replicated component names or addresses may be stored on any machine communicatively connected to the alternate NRS 150. Translation of original component names to replicated component names is described further herein below with respect to FIG. 4.

In S340, the name of the second replicated component is sent to at least another NRS (e.g., the NRS 160) from the list of NRSs. The name may be sent to each NRS included in the list of NRSs. In an embodiment, if a name is not resolved in an NRS, the next NRS on the list of NRSs is queried. In embodiments where the alternate NRS contains a name resolving table, the alternate NRS (e.g. alternate NRS 150) may function as the at least another NRS.

In S350, an address of the second replicated component is received from the NRS. In one exemplary embodiment, the N2N and NRS servers are Domain Name Resolution Servers (DNS), and the component names are domain names.

FIG. 4 is an exemplary and non-limiting flowchart S330 illustrating translation of an original component name to a replicated component name according to an embodiment. In this embodiment, the translation may be performed by an alternate NRS (e.g., the alternate NRS 150). In S410, a request to translate a name of an original component and the name of the original component are received. In S420, a query containing the name of the original component is sent to a table stored on another NRS (e.g., the NRS 160). The table stored on the alternate NRS contains a translation between original component names and replicated component names or addresses. The translation may include, but is not limited to, an identification of each replicated component name that corresponds to an original component name, an identification of each replicated component address that corresponds to an original component address, an identification of each original component name that corresponds to a replicated component address, and so on.

In S430, a name or an address of a replicated component that corresponds to the original component is received from the table. In an optional embodiment, in S435, an address of the replicated component that corresponds to the original component is received from the other NRS, i.e., an NRS other than the alternate NRS.

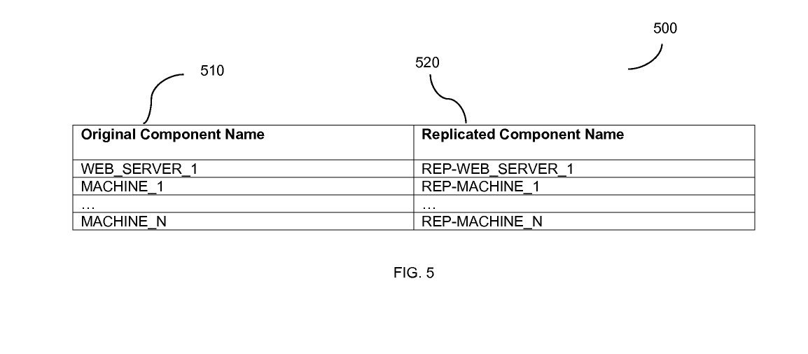

FIG. 5 is an exemplary and non-limiting translation table 500 featuring translations between original component names and replicated component names and/or addresses utilized according to an embodiment. The table contains a list 510 of original component names, and a list 520 of corresponding replicated component names and/or addresses for each component, or part thereof, in a cloud environment. In the exemplary table shown in FIG. 5, the list 520 contains corresponding replicated component names.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for name resolution of replicated components in computing environments (CEs), comprising:
inserting, an alternate name-resolving server (NRS) as a first queried entry in a list of NRSs into a memory of a first replicated component, wherein the alternative NRS is communicatively connected to a second CE, the second CE comprising the first replicated component and the second replicated component, wherein the second replicated component is replicated from the first CE and includes a first original component.

2. The method of claim 1, further comprising:
receiving, by the alternate NRS, a name-to-address (N2A) request from the first replicated component, wherein the N2A request comprises a name of a second original component, wherein the first CE further includes the second original component and the first original component;
translating the name of the second original component to a name of the second replicated component;
sending the name of the second replicated component to at least an NRS of the list of NRSs; and
receiving an address of the second replicated component.

3. The method of claim 2, further comprising:
sending the received address of the second replicated component to the first replicated component.

4. The method of claim 2, wherein translating the name of the second original component to the name of the second replicated component further comprises:
sending, to a name-to-name (N2N) server, a request comprising the name of the second original component; and
receiving, from the name-to-name server, the name of the second replicated component.

5. The method of claim 4, wherein the first replicated component comprises the N2N server.

6. The method of claim 4, wherein the N2N server and the at least an alternate NRS are implemented on a single machine.

7. The method of claim 2, wherein the first replicated component comprises the alternate NRS.

8. The method of claim 2, wherein the memory is at least one of: a volatile memory, a non-volatile memory (NVM), and a hard disk drive (HDD).

9. The method of claim 2, wherein the at least an alternate NRS comprises at least a table, wherein the at least a table further comprises any of: a plurality of translations between a plurality of original component names and a plurality of respective replicated component names, and a plurality of translations between a plurality of original component names and a plurality of respective replicated component addresses.

10. The method of claim 9, wherein translating the name of the second original component to the name of the second replicated component further comprises:
sending a query to the at least a table, wherein the query comprises the at least a name of the second original component; and
receiving, from the at least a table, an address of the second replicated component that corresponds to the name of the second original component.

11. The method of claim 2, further comprising:
determining whether the N2A request has been resolved respective of the at least a NRS of the list of NRSs; and
upon determining that the N2A request has not been resolved respective of the at least a NRS of the list of NRSs, sending the name of the second replicated component to at least a second NRS of the list of NRSs.

12. The method of claim 2, wherein the alternate NRS is the at least another NRS.

13. The method of claim 1, wherein an injector module inserts the alternate NRS into a list of NRSs, wherein the injector module is executed on the alternate NRS.

14. A non-transitory computer readable medium having stored thereon instructions for causing one or more processing units to execute the method according to claim 1.

15. A system for name-to-address (N2A) resolution of a first replicated component in a first computing environment (CE), comprising:
a processing system;
a memory containing instructions that, when executed by the processing system, configure the system to:
insert at least an alternate name-resolving server (NRS) as a first queried entry in a list of NRSs into a memory of the first replicated component, wherein the at least an alternative NRS is communicatively connected to a second CE, the second CE includes the first replicated component and a second replicated component, wherein the second replicated component is replicated from the first CE and includes a first original component;
receive, from the first replicated component, the name-to-name request, wherein the name-to-name request including a name of a second original component, the first CE comprises the second original component;
translate the name of the second original component to a name of the second replicated component;
send the name of the second replicated component to the at least NRS of the list of NRSs; and
receive an address of the second replicated component.

16. The system of claim 15, wherein the system is further configured to:
send, to a name-to-name (N2N) server, a request comprising the name of the second original component; and
receive, from the N2N server, the name of the second replicated component that corresponds to the name of the second original component.

17. The system of claim 16, wherein the first replicated component comprises the N2N server.

18. The system of claim 16, wherein the N2N server and the at least an alternate NRS are implemented on a single machine.

19. The system of claim 11, wherein the replicated component comprises the at least an alternate NRS.

20. The system of claim 11, wherein the memory is at least one of: a volatile memory, a non-volatile memory (NVM), and a hard disk drive (HDD).

21. The system of claim 11, wherein the memory comprises at least a table, wherein the at least a table further comprises any of: a plurality of translations between a plurality of original component names and a plurality of replicated component names, and a plurality of translations between a plurality of original component names and a plurality of replicated component addresses.

22. The system of claim 21, wherein the system is further configured to:
send a query to the at least a table, wherein the query comprises the at least a name of the second original component; and
receive, from the at least a table, an address of the second replicated component that corresponds to the name of the second original component.

23. The system of claim 11, wherein the system is further configured to:
determine whether the name has been resolved respective of the at least a NRS of the list of NRSs; and
upon determining that the name has not been resolved respective of the at least a NRS of the list of NRSs, send the name of the second replicated component to at least a second NRS of the list of NRSs.
